(19) United States
(12) Patent Application Publication
(10) Pub. No.: US 2005/0163912 A1
(43) Pub. Date: Jul. 28, 2005

(54) Method for making beef jerky

(76) Inventor: Randall White, Annville, PA (US)

Correspondence Address: Theresa M. Seal;C/O The Inverntor's Network, Inc, 332 Academy Street, Carnegie, PA, 15106, US

(21) Appl. No.: 10/764,369

(22) Filed: Jan. 26, 2004

(51) Int. Cl. A23L 1/31

(52) U.S. Cl. 426/641

(57) ABSTRACT

A method and process for producing a new type of beef jerky having a unique and distinctive aroma and flavor includes marinating the thinly sliced jerky strips with ingredients that include soy sauce, teriyaki sauce, Worcestershire sauce, mesquite liquid smoke and salt for up to two hours thereby producing aromatic beef jerky strips that can be easily broken into bite size portions by one's hands and fingers.

### FIELD OF THE INVENTION

The present invention pertains to making beef jerky, and more particularly pertains to a process for making a more flavorful, aromatic beef jerky.

### BACKGROUND OF THE INVENTION

Dehydrated or dried meat products in the form of edible jerky strips are a widely popular consumer snack food product. Jerky is most commonly formed from beef, and as it is a nutritious snack food that does not require refrigeration, jerky is thus easy to store and transport. Therefore, jerky is an ideal snack to take on vacations and outdoor activities such as hiking, bicycling, camping, and backpacking as the jerky strips can be stored in a purse, pouch, or backpack and easily taken out, distributed and consumed as needed.

A range of methods and processes have been used for dehydrating the meat product (generally derived from cut strips of striate muscle meat), and methods of dehydration include the use of hot air, drying the product in a drying chamber, and dehydration by heating in oil or fat in a vacuum. In order to enhance the taste of the jerky, the ground jerky components are intermixed with seasoning or curing agents that can include sugar, salt, corn syrup, hydrolyzed plant protein, flavorings, sodium erythorbate and sodium nitrite. It is often necessary to let the jerky components and the curing or seasoning agents stand for a time so that the agents can thoroughly intermix and permeate the jerky components. However, even utilizing the above methods often produces jerky that is friable when handled, and has a glossy, artificial exterior appearance that contrasts unfavorably with the distinctly rugged appearance of natural jerky.

The prior art includes numerous methods, techniques and processes for producing jerky having a desirable exterior appearance as well as a savory, appealing smell and taste.

For example, the Roth patent (U.S. Pat. No. 4,239,785) discloses a method of making ground and formed jerky that includes that includes the steps of grinding the jerky, blending the jerky with curing and seasoning agents, and then extruding the jerky onto a freezer drum for chilling and cooling whereupon the jerky can be transported to a packaging station.

The Meyer et al. patent (U.S. Pat. No. 4,262,028) discloses a method for producing a puffable food composition from ground animal parts so that the end product has the appearance of fried pork skins with a critical step in the process being to maintain the extruder at a temperature wherein the starch and animal parts are at least partially gelatinized.

The Lewis et al. patent (U.S. Pat. No. 4,384,009) discloses a process for making a dehydrated meat product wherein the dehydrated uncooked pieces are heated for a time period that is adequate to reduce the water activity level to between 0.70 and 0.85 and the moisture content to between 15 and 45 per cent.

The Scaglione et al. patent (U.S. Pat. No. 4,868,002) discloses a process for preparing jerky product that includes the steps of combining and mixing the meat dough, extruding the meat dough through a directional flow bar for aligning the meat fibers, and cutting the meat dough perpendicular to the axis of the directional flow of extrusion.

The Ray patent (U.S. Pat. No. 5,290,584) discloses a method of preparing a jerky product that includes the steps of freezing, comminuting, blending and extruding while heating and pressurizing the material to produce the jerky-like food product.

Nonetheless, there still remains a need for a new type of beef jerky that has a unique and distinctive aroma and flavor.

### SUMMARY OF THE INVENTION

The present invention comprehends a recipe and processing steps for producing a new type of beef jerky. In order to produce the beef jerky of the present invention, the meat product is sliced thin and then marinated for up to two hours. When the meat product turns brown it is placed in a dehydrator until it becomes crisp. The ingredients with which the meat product is marinated include soy sauce, teriyaki sauce, Worcestershire sauce, mesquite liquid smoke, and salt.

It is an objective of the present invention to produce a new type of beef jerky that has a unique flavor not currently available on the market.

It is another objective of the present invention to produce a new type of beef jerky that can be broken by one's fingers into bite size pieces.

It is yet another objective of the present invention to produce a new type of beef jerky that is very thinly sliced so that pieces of the jerky can be easily broken off by one's fingers.

These and other objects, features, and advantages will become apparent to one skilled in the art upon a perusal of the following detailed description read in conjunction with the following drawing figures.

### BRIEF DESCRIPTION OF THE DRAWINGS

FIG. 1 is a perspective view of strips of the beef jerky of the present invention partially protruding from a package;

FIG. 2 is a perspective view of one strip of beef jerky containing the ingredients set forth in the present invention; and

FIG. 3 is a perspective view of one strip of beef jerky of the present invention being broken in half for consumption by the individual.

### DETAILED DESCRIPTION OF THE PREFERRED EMBODIMENT

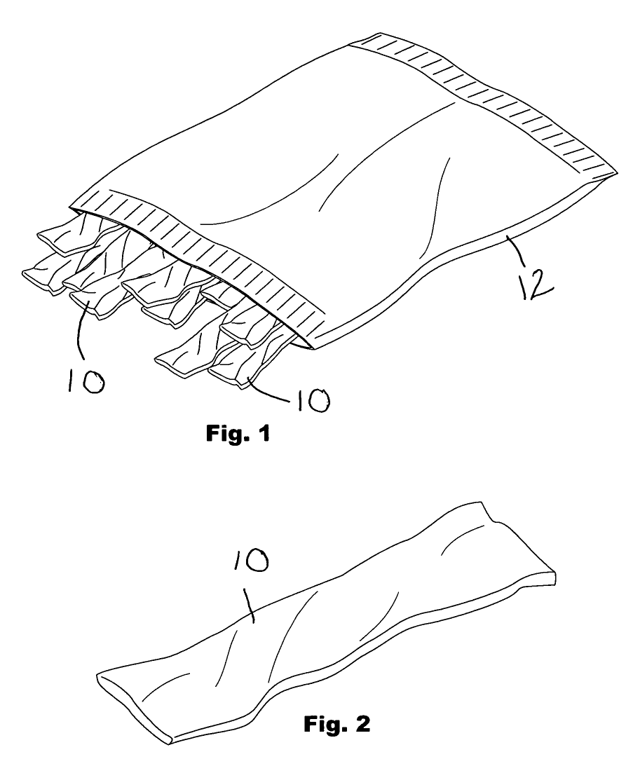

Illustrated in FIGS. 1-3 are strips or slices of beef jerky meat product that have a unique and distinctive aroma and taste as a result of the ingredients with which the jerky strips are intermixed during the processing of the beef jerky strips. The beef jerky strips of the present invention provide a nutritious and tasty snack for individuals, and they are especially suitable as an easily portable snack for individuals on the go and engaged in outdoor activities such as bicycling, hiking, backpacking, boating, camping, and visiting amusement parks.

The following steps are necessary for producing the new type of beef jerky of the present invention. First, the meat product—the beef parts—must be thinly sliced. Then the thinly sliced beef strips must be marinated for up to two hours with the following ingredients: soy sauce, teriyaki sauce, mesquite liquid smoke, Worcestershire sauce, and salt. When the beef strips turn brown the beef strips can then be put in a dehydrator until they turn crisp. The beef strips can then be packaged as a new type of beef jerky having a unique and distinctive aroma and taste.

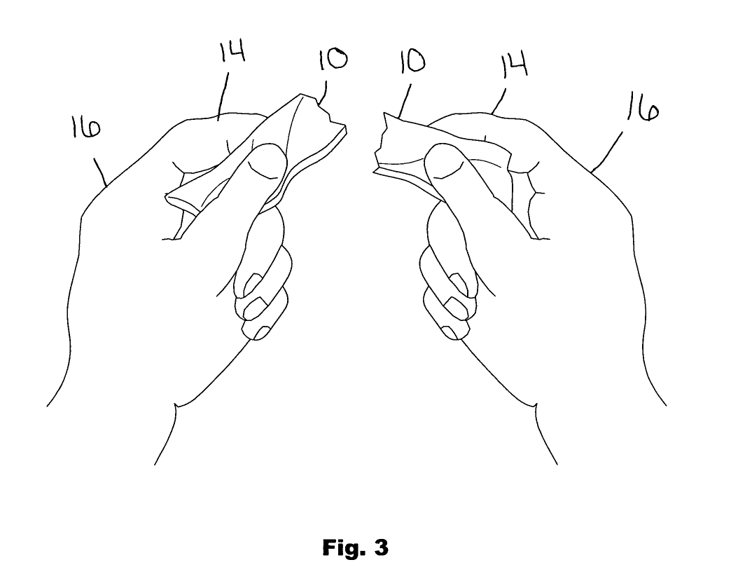

Thus, FIG. 1 shows beef jerky strips 10 partially protruding from a package 12 and FIG. 2 illustrates one thinly sliced beef jerky strip 10. FIG. 3 illustrates the ease with which one beef jerky strip 10 can be broken into bite size pieces by one's fingers 14 and hands 16 in contrast to other types of beef jerky that are presently on the market and are too thick to be broken into bite size pieces.

Numerous modifications, alterations, and variations of the present invention are possible and practicable, and will become apparent to those skilled in the art, and, accordingly such modifications, alterations, and variations will fall within the scope of the present invention and the appended claims.

1. A method of producing beef jerky having a unique and distinctive aroma and flavor, which comprises the steps of:
slicing the beef product into thin strips;
marinating the beef strips for up to two hours with soy sauce, teriyaki sauce, mesquite liquid smoke, Worcestershire sauce, and salt;
dehydrating the beef strips until they become crisp; and
packaging the beef strips into containers.

2. Beef jerky strips having a unique and distinctive aroma and taste, comprising:
a plurality of thinly sliced beef strips;
the beef strips intermixed and soaked in soy sauce, teriyaki sauce, Worcestershire sauce, mesquite liquid smoke, and salt; and
the beef strips dehydrated until they are crisp and capable of being broken into pieces by an individual's hands and fingers.
